(19) United States
(12) Patent Application Publication
(10) Pub. No.: US 2006/0127293 A1
(43) Pub. Date: Jun. 15, 2006

(54) System and method for processing semiconductor material using radiant energy source

(75) Inventors: Charles E. Venditti, Mechanicsville, VA (US); Christopher M. Devany, Mechanicsville, VA (US); Eric E. Thompson, Glen Allen, VA (US); Gary W. Skinner, Midlothian, VA (US); David A. Griffiths, Mechanicsville, VA (US)

Correspondence Address: BRINKS HOFER GILSON & LIONE;INFINEON, PO BOX 10395, CHICAGO, IL, 60610, US

(73) Assignee: Infineon Technologies Richmond LP, Sandston, VA (US)

(21) Appl. No.: 11/348,712

(22) Filed: Feb. 7, 2006

Related U.S. Application Data
(63) Continuation-in-part of application No. 10/963,400, filed on Oct. 12, 2004.

(51) Int. Cl. B01D 53/68; B01D 53/70; B01D 53/50; F01N 3/20

(52) U.S. Cl. 423/240 R; 422/105; 422/107

(57) ABSTRACT

A system and method for processing a semiconductor material out-gassing a gas including a radiant energy source arranged to expose the semiconductor material to energy to decompose the gas and a sensor to sense a parameter of processing such that the radiant energy source is controlled based upon the sensed parameter information.

### REFERENCE TO RELATED APPLICATIONS

This application is a continuation-in-part under 37 C.F.R. § 1.53(b) of U.S. patent application Ser. No. 10/963,400 filed Oct. 12, 2004 (Attorney Docket No. 2004P53318US (BHGL Ref. No. 10808/159)) now U.S. Pat. No. ______, the entire disclosure of which is hereby incorporated by reference.

### BACKGROUND

Economical manufacturing of integrated circuits, such as microprocessors, requires mass production wherein several hundred dies, or circuit patterns, may be created on the surface of a silicon wafer simultaneously. Integrated circuits are typically constructed by a process of deposition and removal of conducting, insulating, and semi-conducting materials one thin layer at a time until, after hundreds of separate steps, a complex sandwich is constructed that contains all the interconnected circuitry of the integrated circuit. The silicon wafer and the thin films on top of the surface of the wafer are used for the electronic circuit. In one exemplary integrated circuit fabrication process, the processing steps include substrate creation and various combinations of oxidation, lithography, etching, ion implantation, and film deposition. The bulk of these steps are repeated over and over to build up the various layers of circuits. It will be appreciated that there are many different techniques for fabricating integrated circuits.

In the exemplary process, the first step in producing an integrated circuit is the creation of an ultrapure silicon substrate, a silicon slice in the shape of a round wafer that is polished to a mirror-like smoothness.

In the oxidation step, an electrically non-conducting layer, called a dielectric, is placed between each conductive layer on the wafer. One type of dielectric is silicon dioxide, which is “grown” by exposing the silicon wafer to oxygen in a furnace at about 1000° C. (about 1800° F.). The oxygen combines with the silicon to form a thin layer of oxide about 75 angstroms deep.

Nearly every layer that is deposited on the wafer must be patterned accurately into the shape of the transistors and other electronic elements. Usually this is done in a process known as photolithography, which is analogous to transforming the wafer into a piece of photographic film and projecting a picture of the circuit on it. A coating on the surface of the wafer, called the photoresist or resist, changes when exposed to light, making it easy to dissolve in a developing solution. These patterns may be as small as 0.25 microns or smaller in size. Because the shortest wavelength of visible light is about 0.5 microns, short-wavelength ultraviolet light may be used to resolve the tiny details of the patterns. After photolithography, the wafer is etched—that is, the resist is removed from the wafer either by chemicals, in a process known as wet etching, or by exposure to a process gas, such as a corrosive gas, called a plasma, in a special vacuum chamber.

In the next step of the process, ion implantation, also called doping, impurities such as boron and phosphorus are introduced into the silicon to alter its conductivity. This is accomplished by ionizing the boron or phosphorus atoms (stripping off one or two electrons) and propelling them at the wafer with an ion implanter at very high energies. The ions become embedded in the surface of the wafer.

The thin layers used to build up an integrated circuit, such as a microprocessor, are referred to as films. In the final step of the process, the films are deposited using sputterers in which thin films are grown in a plasma; by means of evaporation, whereby the material is melted and then evaporated coating the wafer; or by means of chemical-vapor deposition, whereby the material condenses from a gas at low or atmospheric pressure. In each case, the film must be of high purity and thickness must be controlled within a small fraction of a micron.

Integrated circuit features are so small and precise that a single speck of dust can destroy an entire die. The rooms used for integrated circuit creation are called clean rooms because the air in them is extremely well filtered and virtually free of dust. The purest of today's clean rooms are referred to as class 1, indicating that there is no more than one speck of dust per cubic foot of air. (For comparison, a typical home is class one million or so.)

In order to accomplish the various manufacturing processes, many different chemicals are used, such as acids. These chemicals may be toxic to humans, corrosive to machinery, and/or generally hazardous. Further, the requirements for handling these chemicals may require additional processing steps or machinery adding to the necessary costs and resources. Accordingly, there is a need to contain and manage these hazardous chemicals to ensure a safe work environment, minimize additional costs and resources required to handle these chemicals, as well as minimize damage and/or premature wear to manufacturing systems.

### BRIEF DESCRIPTION OF THE DRAWINGS

FIG. 1 depicts a block diagram of an exemplary vapor reduction system according to one embodiment.

FIG. 2 is a flow chart depicting an exemplary process according to the embodiment of FIG. 1.

FIGS. 3A and 3B depict block diagrams of an exemplary vapor reduction system according to a second embodiment.

FIG. 4 depicts a block diagram of an exemplary vapor reduction system according to a third embodiment.

FIG. 5 depicts a block diagram of an exemplary vapor reduction system according to a fourth embodiment.

FIG. 6 is a flow chart depicting the operations of the embodiments of FIGS. 3-5.

### DETAILED DESCRIPTION OF THE DRAWINGS AND PRESENTLY PREFERRED EMBODIMENTS

A system and method is provided for reducing the presence of process gasses, including corrosive gasses, from processed semiconductor materials and from semiconductor processing equipment. The process gasses include residual process gasses and/or process gasses produced by out-gassing, i.e. discharge or emissions, from semiconductor processing equipment and from processed semiconductor materials. Out-gassing is the release of gasses from the surfaces of a solid body. In the disclosed system and method, after the requisite semiconductor processing has completed, a radiant energy source, such as an ultraviolet light source, exposes the process gas and/or processed semiconductor materials, e.g. wafers, while the gas or materials are still contained within the processing equipment. The ultraviolet light energy disassociates the molecules of the gas. The disassociated species may then combine into volatile molecules that may be evacuated through a pumping system to an exhaust system. The processing equipment can then be opened releasing fewer corrosive components into the surrounding environment and/or hazardous material handling or recovery systems.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The disclosed embodiments expose the contained gas and semiconductor materials to energy from a radiant energy source which converts the gas into a lesser corrosive form which can be safely and effectively handled, either by release into the surrounding environment or by venting away, such as with an exhaust system. Introducing the radiant energy source may require minimal modifications to existing equipment and process flows. Process gasses as discussed herein include any gas that dissociates or decomposes when exposed to energy from a radiant energy source.

Common chemicals/process gasses used in semiconductor processing include inorganic acids, i.e. acids which have no hydrocarbons, such as Hydrogen Bromide (“HBr”), Hydrogen Chloride (“HCl”) or Hydrogen Fluoride (“HF”). These chemicals are also referred to as Hydrogen Halides, i.e. a halogen element, any of the five nonmetallic elements that comprise Group VIIa of the periodic table. The halogen elements are fluorine (F), chlorine (Cl), bromine (Br), iodine (I), and astatine (At). These chemicals are commonly used in the etch processing of semiconductor wafers. To perform the etching process, the wafers are introduced into an etch chamber which is then sealed. The etching chemicals, such as those described above, are then introduced into the chamber. After the etching process is complete, the chamber is opened to remove and continue processing the wafers. At this time, the residual etching chemicals present in the processed semiconductor wafers may be released, i.e. out-gassed, to the surrounding environment as was described. For example, typically these process gasses contaminate, i.e. are released near or on, the process devices which move the wafers around or the process devices which are used in subsequent wafer processing, causing premature corrosion, etc. It will be appreciated that the disclosed embodiments may be utilized to decompose any process gasses and/or chemicals that dissociate when exposed to energy from a radiant energy source.

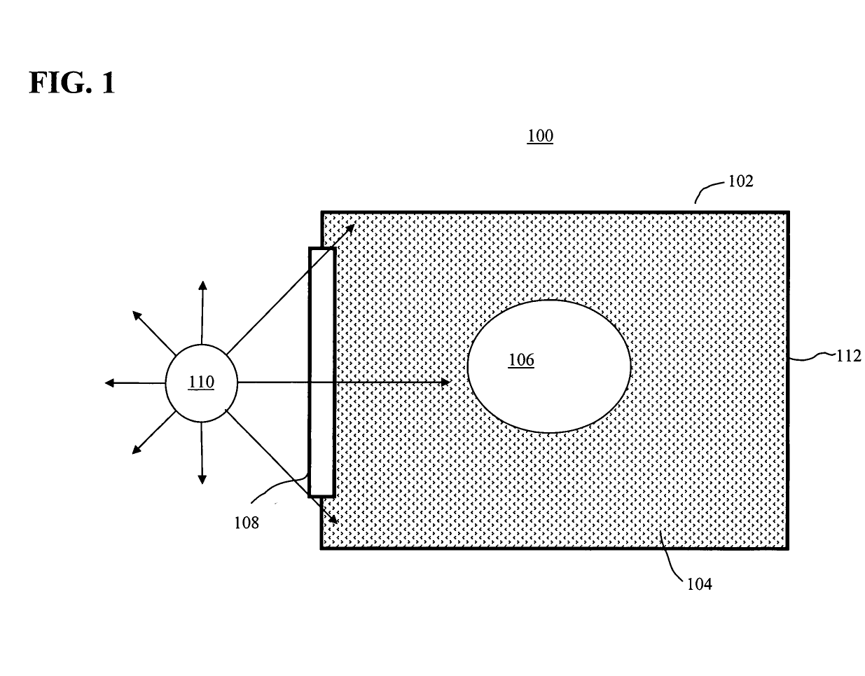

FIG. 1 shows a block diagram of an exemplary vapor reduction system according to one embodiment. The system 100 includes a semiconductor manufacturing/processing device 102, such as a process chamber, a buffer/transfer chamber or a load lock. In one embodiment, the processing device 102 is a load lock which is used to load/unload wafers or other semiconductor materials 106 into other processing devices 102 in order to protect the environmental conditions therein. In an alternate embodiment, the processing device 102 is an etch chamber. The processing device 102 includes a housing 112 which, when closed, acts to contain process gas emissions within the interior of the housing and prevent those gasses from escaping to the surrounding environment. Further, the processing device 102 features a door or other portal (not shown) which may be opened to access the interior of the processing device 102 housing 112 to load and unload semiconductor devices/materials 106, such as silicon wafers, for processing. During processing of semiconductor materials/devices 106, the semiconductor device/material 106 may be located within the processing device 102. If the semiconductor device/material 106 has undergone a process in which it was exposed to process gasses, as described above, either in the current processing device 102 or in previous processing stage using a different processing device 102, there may be residual process gas 104 within the processing device 102. This residual process gas 104 may be present due to out-gassing from the semiconductor materials/device 106 and/or may be left over from the prior processing stage.

The processing device 102 further features a radiant energy transmissive portion, such as a window 108, located in the housing 112. The transmissive portion 108 operates to allow radiant energy to pass into the interior of the processing device 102 without allowing the process gasses contained therein to escape to the surrounding environment. It will be appreciated that while the window 108 is shown on one side of the housing 112, the window 108 may be located anywhere on the housing 112, such as the top portion, and in one embodiment, is located so as to maximize the exposure of the interior and/or semiconductor material 106 to the radiant energy, described below, especially in implementations where support or other structures are included within the housing 112 which may block or otherwise interfere with the exposure. A radiant energy source 110 is located outside the processing device 102 and coupled with the transmissive portion 108 of the housing 112. In one embodiment, the radiant energy source 110 is attached to the processing device 102 so as to expose the semiconductor materials/device 106 contained therein to the maximum amount of radiant energy. The radiant energy source 110 may further include a shield or filter (not shown) to direct substantially all of the radiant energy through the transmissive portion 108 of the housing 112 and/or prevent spillage of the excess radiant energy into the surrounding environment where it may present a health, equipment or materials hazard. Further, in embodiments where the processing device 102 includes more than one window (not shown), such as for allowing visual observation of the processing therein, non-transmissive windows (not shown), such as ultraviolet filtering windows, operable to prevent the transmission of the radiant energy out of the processing device 102, while still permitting visual observation, may be used to prevent spillage of the radiant energy out of processing device 102. The radiant energy acts to decompose the process gas 104 within the housing 112 into lesser corrosive components. In one embodiment, the radiant energy acts to disassociate the molecules of the process gas into the component radical and/or ions thereof. It will be appreciated that these component radicals and/or ions may quickly reform into lesser corrosive and/or more volatile molecules. For example, HBr breaks down into H* and Br*, HCl breaks down into H* and Cl* and HF breaks down into H* and F*. It will be appreciated that these radicals and/or ions may quickly reform into H₂ and Br₂, Cl₂ or F₂, respectively.

In an alternate embodiment, the radiant energy source 110 may be located within the housing 112, obviating the need for radiant energy transmissive windows 108. In this embodiment, the radiant energy source 110 may be shielded, or otherwise protected, from the process gasses 104 within the housing 112. In yet another alternative embodiment, multiple radiant energy sources 110 may be utilized, located inside the housing 112, outside the housing 112 proximate to the same or separate windows 108, or combinations thereof.

In one embodiment, the radiant energy source 110 is a light source having an energy/wavelength sufficient to overcome the disassociation energy, i.e. the energy required to separate atoms from one another within a molecule, also called the bond energy, of the process gas molecules. For example, the light source 110 may include an ultraviolet light source. In one embodiment, a UV light source 10 is attached to the processing device 102 in a location where the maximum amount of UV light can be exposed to the semiconductor materials/wafers 106 within the processing device 102. Ultraviolet is defined as the region of the electromagnetic spectrum that is of higher energy and shorter wavelength than visible light. Typical wavelengths of ultraviolet radiation range from 12.5 nanometers (“nm”) to 1800 nm. In one embodiment, the wavelengths used to decompose the process gas 104 range from about 100 nm to 1800 nm. It will be appreciated that the wavelength used is implementation dependent and may, for example, depend upon the type and mixture of process gases as well as the desired level of resultant decomposition. In one embodiment, the disassociation of hydrogen halides occurs with a quantum yield, i.e. the number of defined events which occur per photon absorbed by the system, of near unity.

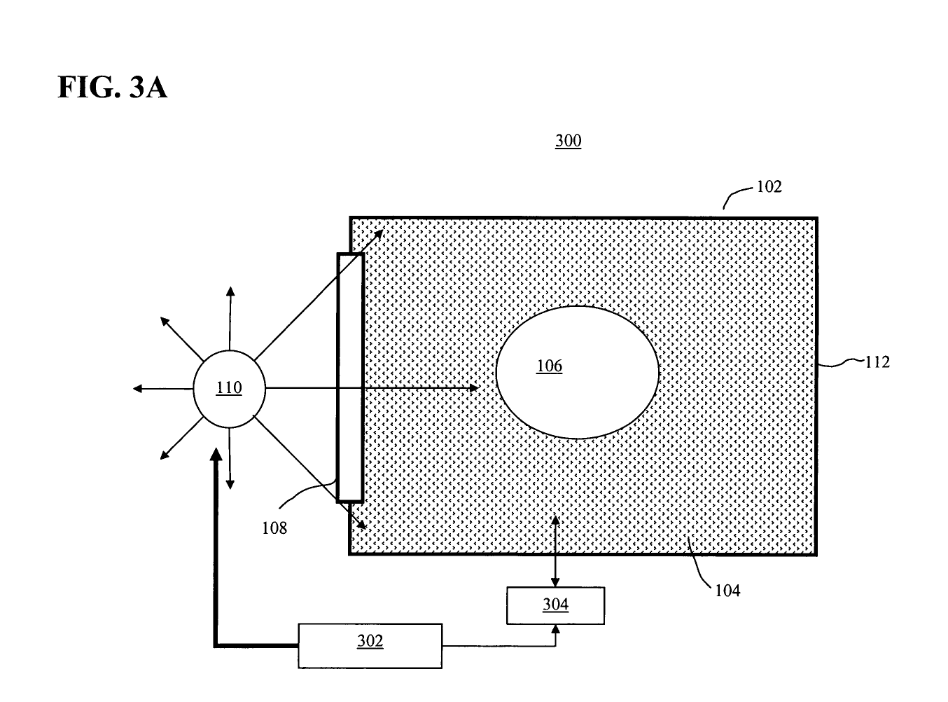

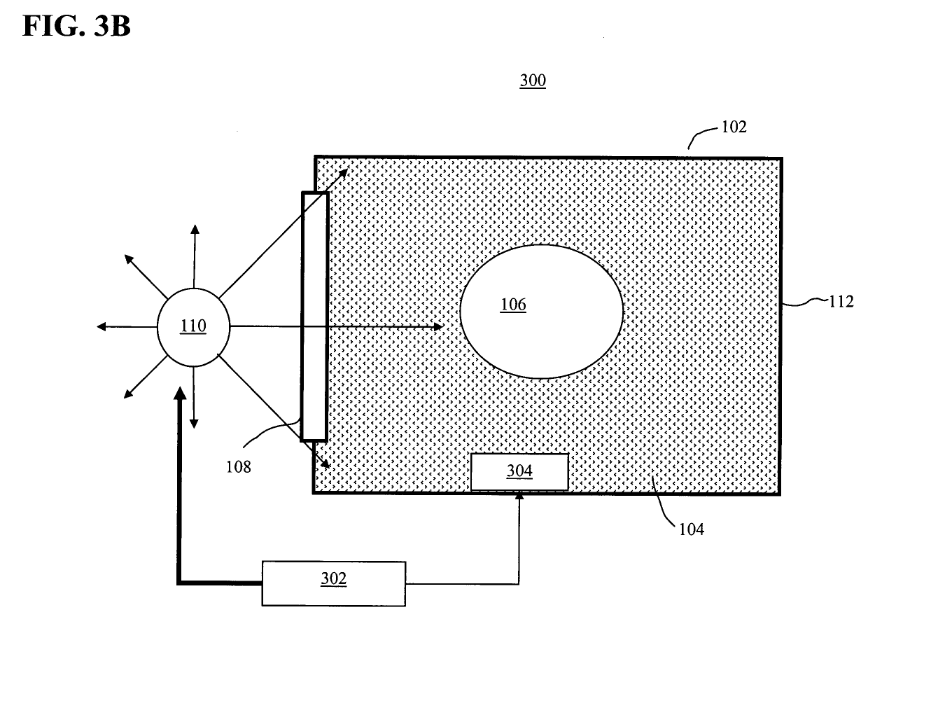

In one embodiment, the radiant light source 110 is activated after completion of the semiconductor processing stage and before the semiconductor materials/devices 106 are removed from the processing device 102. In an alternate embodiment, the radiant light source is continuously active, such as active whenever semiconductor materials/devices are present. In another alternative embodiment, the radiant light source 110 is cycled on and off, whenever semiconductor materials/devices 106 are present. In yet another alternative embodiment, sensors (FIGS. 3A and 3B) which may detect the presence of process gasses are used within the housing 112 and coupled with the radiant light source 110 so as to activate the light source 110 when the levels of gasses exceed a particular threshold and deactivate the light source 110 when the levels drop below the particular threshold.

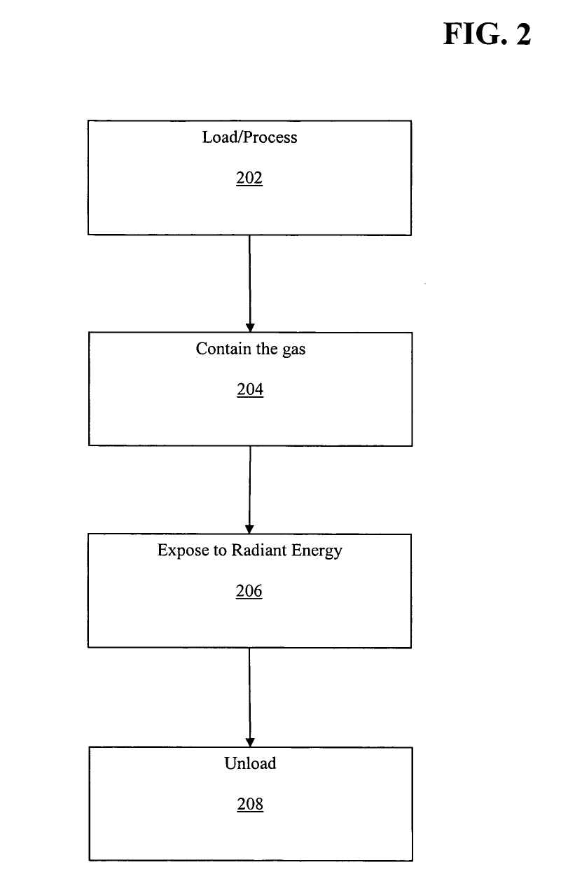

FIG. 2 is a flow chart depicting an exemplary process for the embodiment of FIG. 1. Prior to activating the system 100, the semiconductor materials/devices 106 are loaded and/or processed in the processing device 102 (block 202). The processing device 102 may include a semiconductor fabrication device such as a process chamber, a buffer/transfer chamber, a load-lock, or combinations thereof. The processing device 102 is sealed/closed so as to contain the process gasses 104 used in the processing and/or outgassed by the semiconductor materials/devices 106 within the interior housing 112 (block 204) and separate from the surrounding environment. As described above, the process gasses 104 may include inorganic acids, such as hydrogen halides, including Hydrogen Bromide, Hydrogen Chloride, Hydrogen Fluoride, or combinations thereof.

Once processing has completed on the semiconductor materials/devices 106, if necessary, at least a portion of the interior of the housing 112, and thereby the semiconductor materials/devices 106 are exposed to a radiant energy source while the housing is closed (block 206). In one embodiment, as was described above, the radiant energy source comprises an ultraviolet light source, such as an ultraviolet light source emitting light energy at a wavelength of the energy ranging from about 100 nanometers to 1800 nanometers. In one embodiment, the housing 112 includes a window 108 operative to allow radiant energy to pass from an exterior of the housing to the interior while containing the process gas 104 within the interior, wherein the radiant energy source is located proximate to the window on the outside of the housing 112, as was described above. The window is essentially operative to allow radiant energy to pass from the exterior of the housing to the interior while containing the process gas within the interior. As discussed, the radiant energy source is further operative to emit sufficient energy to substantially convert the process gas into a lesser corrosive form while the housing is closed, e.g. sufficient energy so as to substantially disassociate the hydrogen halide into at least one component radical, component ion or combinations thereof.

Once the process gasses have been decomposed, the housing 112 may be opened to remove the semiconductor materials/devices 106 and continue the manufacturing process (block 208). In so doing, substantially only the residual lesser corrosive components of the process gasses 104 are exposed to the surrounding environment and/or equipment.

Accordingly, the disclosed embodiments result in no extra processing steps, no extra equipment and the exposure of/contamination by the process gasses to the atmosphere, equipment and personnel is minimized. The disclosed embodiments may be used with any semiconductor process/device which may utilize process chemicals capable of being broken down by exposure to radiant energy, such as plasma etch, film deposition, or wet chemical processing. This would include, but not be limited to processes such as Deep Trench (“DT”) Etch tools, Gate Conductor (“GC”) Etch Tools, Recess Etch Tools, Metal Etch Tools, Active Area Isolation Trench (“AAIT”) Tools, Hard Mask Open Tools and or Hard Mask Removal Tools, or any other tools or processes where process gasses are introduced.

In practice, a sample prior to UV treatment was shown to have HBr@3.6 parts per million (“ppm”), HF@96 ppm, and HCl@<0.47 ppm. Subsequent to treatment as disclosed, the sample was shown to have HBr@<0.29 ppm, HF@<1.2 ppm and HCl@<0.32. In comparison, an empty chamber has HBr@<0.15 ppm, HF@<0.62 ppm and HCl@<0.16 ppm.

In another embodiment, feedback control is used in the system shown in FIG. 1 to control the radiant energy source 110. More specifically, one or more sensors are provided to detect the processing conditions within the processing device 102 and this information is used to control the radiant energy source 110, such as to control the activation, deactivation, duration, intensity or area of exposure and/or wavelength of radiant energy. In this way, the present process conditions can be known and maintained allowing for optimum utilization of the radiant energy source 110. This, in turn, allows for efficient use of the processing device 102 by avoiding unnecessarily prolonging the process to complete the decomposition of process gasses while ensuring that substantially all of the gas is treated. For example, premature activation of the radiant energy source 110 may be avoided so as to avoid interfering with the manufacturing process. Similarly, premature deactivation of the radiant energy source 110 may be avoided so as to maximize the decomposition effect. This also extends the life of the radiant energy source 110 by not overusing it, thereby reducing maintenance costs.

Referring to FIGS. 3A and 3B, the system 300 includes the elements shown in FIG. 1 as well as at least one sensor 304 (located external to the housing 112, but in direct or indirect communication with the interior thereof, as shown in FIG. 3A, internal to the housing as shown in FIG. 3B, or utilizing a combination of internal and externally provided sensors 304 (not shown)) which senses at least one parameter of the process, processing device 102, radiant energy source 110 and/or semiconductor material/device 106. The sensor 304 may be selected to detect temperature, such as housing 112 surface temperature, internal atmospheric temperature, and/or semiconductor material/device temperature, etc., pressure, density, humidity, particulate, radiation, capacitance, inductance, resistance, conductivity or other parameters. It will be appreciated that the type and number of sensor(s) 304 utilized is implementation dependent and depends upon the parameter that is desired to be sensed.

For purposes of discussion, the system 300 includes a control unit 302 that couples the sensor 304 with the radiant energy source 110. However, it will be appreciated that many implementations for controlling the radiant energy source are possible. For example, the control unit 302 may be coupled, or integrated, with the processing device 102 control unit (not shown) or process control system (not shown). Alternatively, the control unit 302 may be integrated with the sensor 304 or with the radiant energy source 110. In one embodiment, the sensor 304 and control unit 302 are both integrated with the radiant energy source 110.

In one embodiment, the control unit 302 includes an analog or digital switch or relay which either opens or closes in response to the sensor 304 to activate or deactivate the radiant energy source 110, depending upon the implementation. In an alternative embodiment, the control unit 302 includes logic, implemented as digital logic, analog logic, or a combination thereof, which receives the sensed parameter information provided by the sensor 304 to determine how to control the radiant energy source 110, such as by activating, deactivating, modifying the intensity or modifying the emitted wavelength of the radiant energy source 110. In an embodiment where the sensor 304 include an active sensor, the control unit 302 includes suitable control logic (not shown), programmable or otherwise, to activate the sensor 304 so as to provoke a response which may be detected.

The sensor 304 may include passive sensors, such as infrared or thermal sensors, or active sensors such as an Optical Emission Spectroscopy (OES) sensor. The sensor 304 may be located internal or external to the housing 112, such as in the exhaust mechanism of the device 102 or within the environment in which the device 102 is located to directly or indirectly monitor the requisite parameter or parameters. Further, multiple sensors 304 may be provided so as to sense the given parameter in different locations within the area of interest, such as to detect temperature or density gradients or differentials across the interior volume of the housing 112. In another embodiment, additional sensors (not shown) may be provided to sense other parameters, such as parameters related to the environment external to the housing 112. For example, a sensor may be provided to measure the environmental air temperature, pressure or humidity for the purposes of comparison with similar parameters measured within the housing 112.

In one exemplary embodiment, sensor 304 is of a type which may detect the presence of process gasses within the housing 112, such as a particulate sensor or spectroscopy based sensor, and coupled with the radiant light source 110 so as to activate the light source 110 when the levels of process gasses exceed a particular threshold and deactivate the light source 110 when the levels drop below the particular threshold.

In one embodiment, an OES sensor 304 or Mass Spectrometry based sensor 304 is used to monitor the wavelength(s) of light emanating from the semiconductor material 106 and/or the gasses contained within the housing 112 to determine when a species in the process environment has appeared or disappeared. In FIG. 3, the sensor 304 is an OES sensor coupled with the housing 112 so as to sense the emitted wavelengths via optical emission spectroscopy. The OES sensor 304 is used to monitor the semiconductor material 106 and/or the contents of the housing 112 for the disappearance of a specific wavelength(s) of light. This information may be used to indicate when the decomposition process has substantially completed. The information is supplied to the control unit 302 to control the radiant energy source 110. Process control is enhanced by monitoring the concentration of a specific process gas(ses) in the process environment. The concentration of a process gas is correlated to the signal strength of the light emission sensed by the OES sensor during the process. At the time when the concentration falls below a minimum threshold, the radiant energy source is deactivated.

In one embodiment, the output from the OES sensor 304 is used to control the radiant energy source 10 to maintain a particular concentration of the process gasses within the housing 112, such as for part of the manufacturing process. In this embodiment, the sensor 304 monitors the gas concentration, or an alternate parameter indicative thereof. The control unit 302, in response to the sensed concentration, activates, deactivates or adjusts the intensity or wavelength of the radiant energy source 110 in response to this information to maintain the levels of the gasses below a given threshold, i.e. the desired concentration level.

In another embodiment, the sensor 304 monitors the output of the radiant energy source 110 to ensure a desired and/or consistent output to detect and compensate for degradation or failure of the radiant energy source 110.

In another embodiment, the exhaust gas from the processing device 102 is monitored via an appropriate sensor 304, such as those described above, to determine the concentration of process gasses being emitted from the semiconductor material 106 during process. When the concentration of process gas falls below a minimum threshold, the radiant energy source 110 is deactivated. In an alternate embodiment, a radiant energy source 110 is provided within the exhaust system of the processing device 102 or the room in which the device 102 is located to augment, or supplant, the radiant energy source 110 coupled with the device 102, so as to substantially decompose any process gasses passing through the exhaust system.

In one embodiment, temperature based control is provided for the processing device 102 to enhance process control. In this embodiment, the sensor 304 includes a temperature sensing device, such as a thermocouple, which is located in or around the housing 112 in a location that best approximates the semiconductor material 106 temperature. Alternatively, multiple temperature sensors 304 may be provided so as to be able to sense temperature gradients across the semiconductor material 106 or between the material 106 and the ambient environment within the housing 112. The information from the temperature sensor 304 is used to control the operation of the radiant energy source 110 depending upon a threshold value and/or the process control requirements. In another embodiment, the radiant energy source 110 is cycled on and off to provide for multi-pass processing of the semiconductor material 106. Additionally, temperature control is used to maintain the temperature of the semiconductor material 106 by adjusting the output of the radiant energy source 110. This enables isothermal processing of the semiconductor material 106.

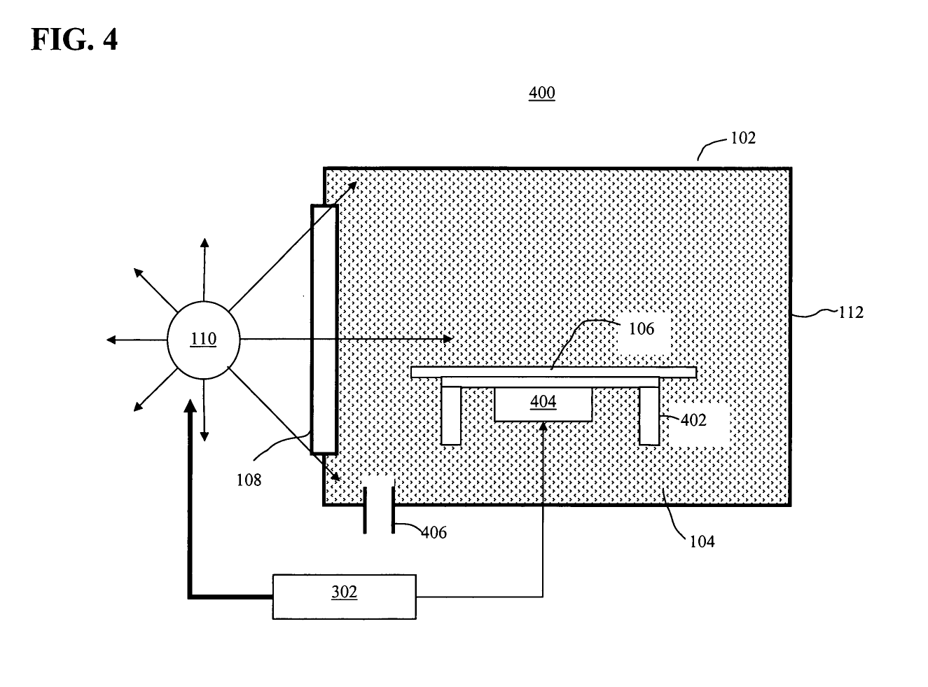

Referring to FIG. 4, a temperature sensor 404 is arranged to detect the temperature of a support structure 402 that supports the semiconductor material 106 within the semiconductor processing device 102 so as to indirectly measure the temperature of the semiconductor material 106. The output from the temperature sensor 404 approximates the temperature of the semiconductor material 106. In this embodiment, the information from the temperature sensor 404 is supplied to the control unit 302 to control the operation of the radiant energy source 110 such as the activation, deactivation, cycling, or intensity of the radiant energy source 110.

In another exemplary embodiment, pressure based control is provided for the processing device 102 to enhance process control. In this embodiment, the sensor 304 includes a pressure sensing device, such as a manometer, which is located in or around the housing 112 in a location where the internal pressure can be sensed. By controlling the pressure at which the semiconductor material 106 is exposed to the radiant energy source 110, the effectiveness of the exposure is influenced by increasing the amount of process gas out-gassed by the material 106 to the ambient environment within the housing 112.

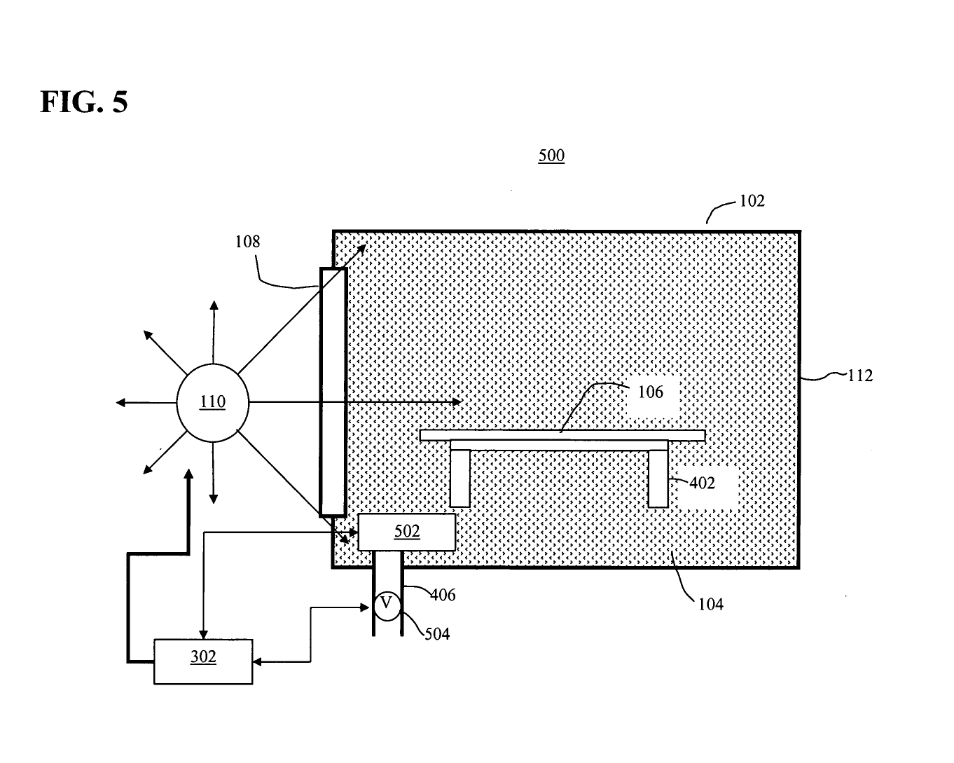

Referring to FIG. 5, a pressure sensor 502 is arranged on an access port 406 to the semiconductor processing device 102, or otherwise in communication with the interior of the housing 112, and detects the pressure within the housing 112 of the semiconductor processing device 102. The pressure information detected by the pressure sensor 502 is supplied to the control unit 302 which controls the pressure at which the semiconductor material 106 is processed via valve 504.

In another embodiment, multiple types of sensors are provided to sense multiple parameters, as described.

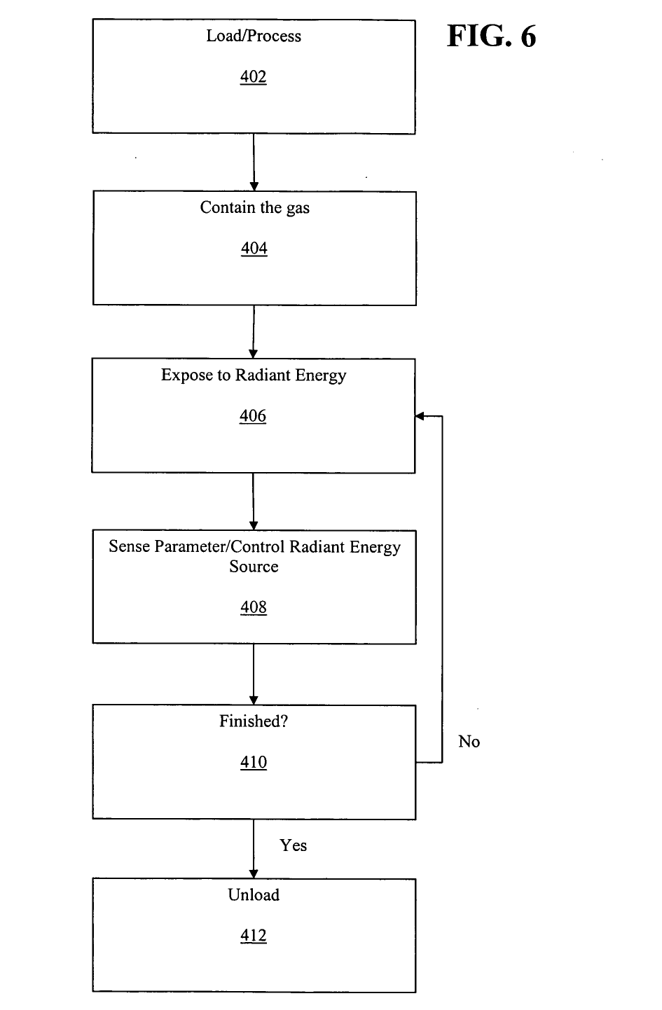

FIG. 6 is a flow chart depicting an exemplary process for reducing process gasses/vapors, including corrosive gasses, according to the embodiment of FIGS. 3-5. Prior to activating the system 100, the semiconductor materials/devices 106 are loaded and/or processed in the processing device 102 (block 402). The processing device 102 is sealed/closed so as to contain the process gasses 104 used in the processing and/or outgassed by the semiconductor materials/devices 106 within the interior housing 112 (block 404) and separate from the surrounding environment.

Either during or following the processing of the semiconductor materials/devices 106, if necessary, at least a portion of the interior of the housing 112, and thereby the semiconductor materials/devices 106 are exposed to a radiant energy source while the housing is closed (block 406). At least one parameter of the process, processing device 102 and/or semiconductor material 106 is monitored/sensed (block 408) to determine when the process gas has been substantially decomposed (block 410). While the sensed parameter indicates the presence of process gas in excess of a particular threshold, the radiant energy source 110 is maintained in an active state. Alternatively, depending upon the sensed parameter, the radiant energy source 110 may be adjusted, such as by adjusting the intensity and/or emitted wavelengths, so as to compensate for the sensed conditions. Once the process gas is determined to have been substantially decomposed within the defined threshold (block 410), the housing 112 may be opened to remove the semiconductor materials/devices 106 and continue the manufacturing process (block 412).

It is therefore intended that the foregoing detailed description be regarded as illustrative rather than limiting, and that it be understood that it is the following claims, including all equivalents, that are intended to define the spirit and scope of this invention.

We claim:

1. A system for processing a semiconductor material out-gassing a gas, the system comprising:
a radiant energy source arranged to expose the semiconductor material to energy to decompose the gas; and
a sensor coupled with the radiant energy source and operative to sense a parameter such that the radiant energy source is controlled based upon the sensed parameter information.

2. The system of claim 1, wherein the parameter comprises at least one of temperature, pressure, density, concentration, radiation, spectral emission, capacitance, inductance, resistance, conductivity or combinations thereof.

3. The system of claim 1, wherein the parameter comprises an amount of the gas, wherein the radiant energy source is activated when the amount of the gas is greater than a predetermined value.

4. The system of claim 1, further comprising control logic coupled between the sensor and the radiant energy source and operative to control the radiant energy source based upon the sensed parameter information.

5. The system of claim 1, wherein the sensor comprises an optical emission spectral sensor that senses a wavelength of light emitted by the gas, and wherein the radiant energy source is controlled in response to the wavelength of light emitted by the gas.

6. The system of claim 1, wherein the sensor comprises a temperature sensor that detects the temperature of the semiconductor material as the parameter, and wherein the radiant energy source is controlled in response to the temperature sensed by the temperature sensor.

7. The system of claim 1, wherein the sensor comprises a pressure sensor that detects parameter of the pressure under which the semiconductor material is processed, and wherein the radiant energy source is controlled in response to the pressure sensed by the pressure sensor.

8. The system of claim 1, wherein the sensor senses the gas exhausted from the system and the radiant energy source is controlled in response to the exhaust gas sensed by the sensor.

9. The system of claim 1, wherein the gas comprises an inorganic acid.

10. The system of claim 1, wherein the gas comprises one of Hydrogen Bromide, Hydrogen Chloride, Hydrogen Fluoride, or combinations thereof.

11. The system of claim 1, wherein the radiant energy source comprises an ultraviolet light source.

12. The system of claim 1, further comprising:
a semiconductor processing device having an interior arranged to support the semiconductor material; and
wherein the radiant energy source exposes the interior of the semiconductor processing device to the energy to decompose the gas.

13. The system of claim 11, wherein the sensor is arranged on the exterior of the semiconductor processing device.

14. The system of claim 11, wherein the sensor is arranged within the interior of the semiconductor processing device.

15. The system of claim 12, wherein the semiconductor processing device comprises a support structure for supporting the semiconductor material, and wherein the sensor comprises a temperature sensor arranged on the support structure to sense the parameter representative of the temperature of the support structure such that the radiant energy source is controlled in response to the temperature of the support structure.

16. The system of claim 12, wherein the sensor comprises a pressure sensor that senses the parameter of pressure within the semiconductor processing device, and wherein the radiant energy source is controlled in response to the pressure sensed by the pressure sensor.

17. The system of claim 4, further comprising:
a semiconductor processing device having an interior arranged to support the semiconductor material;
wherein the radiant energy source exposes the interior of the semiconductor processing device to the energy to decompose the gas; and
wherein the sensor comprises a pressure sensor that senses the parameter of pressure within the semiconductor processing device, and wherein the control logic controls the pressure within the semiconductor processing device by controlling a valve coupled to the semiconductor processing device in response to the pressure sensed by the pressure sensor.

18. The system of claim 1, further comprising:
a semiconductor processing device having an interior arranged to support the semiconductor material and to receive the gas for processing the semiconductor material; and
wherein the energy from the radiant energy source decomposes the gas generated by the out-gassing of the semiconductor material and any residual gas from processing the semiconductor material.

19. A method of manufacturing a semiconductor material, comprising:
exposing the semiconductor material to energy from a radiant energy source to decompose gas out-gassing from the semiconductor material;
sensing a parameter related to at least one of the semiconductor material and the gas or combinations thereof; and
controlling the radiant energy source based on the sensed parameter.

20. The method of claim 19, further comprising:
loading the semiconductor material into an interior of a semiconductor processing device; and
supplying the gas into the semiconductor processing device for processing the semiconductor material.

21. The method of claim 20, wherein the exposing step comprises exposing the semiconductor material and the interior of the semiconductor device to the energy from the radiant energy source to decompose the gas out-gassing from the semiconductor material and any residual gas from processing the semiconductor material.

22. The method of claim 20, wherein the controlling step comprises:
controlling the exposure of the semiconductor material and the interior of the semiconductor processing device to the emission of the energy from the radiant energy source to decompose the gas based on the sensed parameter.

23. The method of claim 19, wherein the sensing step comprises sensing the temperature of the semiconductor material, and wherein the controlling step comprises controlling the radiant energy source based upon the temperature sensed in the sensing step.

24. The method of claim 19, wherein the sensing step comprises sensing the pressure at which the semiconductor material is processed, and wherein the controlling step comprises controlling the radiant energy source based upon the pressure sensed in the sensing step.

25. The method of claim 19, wherein the sensing step comprises sensing the wavelength of light emitted by the gas, and wherein the controlling step comprises controlling the radiant energy source based upon the wavelength sensed in the sensing step.

26. A system for processing a semiconductor material out-gassing a gas, comprising:
means for exposing the semiconductor means to energy to decompose the gas; and
means for sensing a parameter of the processing such that the exposing means is controlled in response to the sensed parameter.

27. The system of claim 26, further comprising:
means for supporting the semiconductor material and for receiving the gas for processing the semiconductor material; and
wherein the energy from the exposing means decomposes the gas generated by the out-gassing of the semiconductor material and any residual gas from processing the semiconductor material.

28. A system comprising:
means for containing a gas in an interior of a semiconductor processing device;
means for exposing at least a portion of the interior of the semiconductor processing device to a radiant energy source emitting sufficient radiant energy to substantially decompose the gas; and
means for sensing a parameter such that the radiant energy source is controlled in response to the parameter sensed by the sensing means.

29. A system comprising:
a semiconductor processing device having an interior in which a gas is contained;
a radiant energy source exposed to at least a portion of the interior and capable of emitting sufficient energy to substantially decompose the gas; and
a sensor operative to sense a parameter and control the radiant energy source based thereon.
